(19) United States
(12) Patent Application Publication
(10) Pub. No.: US 2023/0027830 A1
(43) Pub. Date: Jan. 26, 2023

(54) INDUCTIVE COOKTOP SYSTEM WITH DISPLAY INTERFACE

(71) Applicant: GHSP, Inc., Holland, MI (US)

(72) Inventors: Cort Corwin, Grand Haven, MI (US); Andrew Foley, Holland, MI (US); Ian Sage, Holland, MI (US); Dave Jerovsek, Grand Haven, MI (US)

(21) Appl. No.: 17/758,499

(22) PCT Filed: Jan. 7, 2021
(86) PCT No.: PCT/US2021/012483

§ 371 Date: Jul. 7, 2022

Related U.S. Application Data
(60) Provisional application No. 62/958,268, filed on Jan. 7, 2020.

(51) Int. Cl. F24C 7/08; G06F 3/147; H05B 6/12

(52) U.S. Cl. CPC F24C 7/083; G06F 3/147; H05B 6/1209; F24C 7/086

(57) ABSTRACT

An inductive cooktop system includes a top plate that has a top surface for supporting a cookware object. A display is disposed below the top plate, and induction coils are arranged in a matrix and disposed vertically below the display. The induction coils are each operable to generate a magnetic field that partially extends above the top surface of the top plate to couple with the cookware object. A control system receives an initial input indicating a position of the cookware object on the top surface of the top plate. Data processing hardware of the control system then determines the pixels of the display corresponding to the indicated position from the input. The control system then generates a graphic at the indicated position for the cookware object by illuminating the plurality of pixels of the display.

### CROSS-REFERENCE TO RELATED APPLICATION

This application claims priority under 35 U.S.C § 119(e) to U.S. Provisional Patent Application No. 62/958,268, filed Jan. 7, 2020, the disclosure of this prior application is considered part of this application and is hereby incorporated by reference in its entirety.

### TECHNICAL FIELD

This disclosure relates to an inductive cooktop system with a display.

### BACKGROUND

Kitchens or other areas used to prepare and cook food may have an inductive cooktop, such as a cooktop that is part of a range unit or a separate cooktop unit that is placed on or installed directly in a countertop or other work surface. It is known that inductive cooktops can be used to effectively heat metal cookware that is capable of inductively coupling with an electromagnetic field generated by the cooktop.

It is common for inductive cooktops to have a top panel that supports cookware on the cooktop, such that during use, the top panel often is conductively heated by the inductively heated cookware. The residual heat at the top surface of the top panel is often dangerous to touch and is difficult and sometime unable to be visibly recognized. Presently known measures to indicate a hot top surface are provide by a separate lights adjacent to the hot area or with messages displayed on relatively small display screens at the front edge of the cooktop, which is located a significant distance away from the actual hot area of the top surface.

### SUMMARY

The present disclosure provides an inductive cooktop system and corresponding methods for an integrated display interface that operates to control induction coils of the cooktop and provide customizable operability of the cooktop by utilizing the display. According to one aspect of the present disclosure, an inductive cooktop system includes a top plate that has a top surface for supporting a cookware object. A display is disposed below the top plate, and induction coils are arranged in a matrix and disposed vertically below the display. The induction coils are each operable to generate a magnetic field that partially extends above the top surface of the top plate to couple with the cookware object. A control system receives an initial input indicating a position of the cookware object on the top surface of the top plate. Data processing hardware of the control system then determines the pixels of the display corresponding to the indicated position from the input. The control system then generates a graphic at the indicated position for the cookware object by illuminating the plurality of pixels of the display.

Implementations of the disclosure may include one or more of the following optional features. In some implementations, the control system is further configured to receive, at the data processing hardware, a second input indicating a change of position of the cookware object on the top surface of the top plate. The control system may determine, by the data processing hardware, a second plurality of pixels of the display corresponding to the indicated change of position from the second input. A second graphic is generated, by the data processing hardware, at a respective position corresponding to the indicated change of position for the cookware object by illuminating the second plurality of pixels of the display. The data processing hardware may further extinguish the plurality of pixels corresponding to the initial input.

In some implementations, generating the graphic representation further includes generating a selectable menu graphic alongside the graphic at the indicated position for the cookware object. In some examples, the control system is further configured to receive, at the data processing hardware, a selection input for a menu item graphic displayed in the selectable menu from a peripheral device in contact with the top surface of the top plate. A second plurality of pixels of the display may be determined by the data processing hardware to correspond to an area adjacent a position of the selectable menu. In addition, a third graphic may be generated by the data processing hardware representing cooktop information by illuminating the second plurality of pixels of the display.

In further implementations, the graphic representing cooktop information includes a temperature dial that corresponds to a temperature generated by at least one solenoid coil inductively heating the cookware object on the top surface of the top plate. The graphic representing cooktop information, in some examples, includes a digital cooking timer that is configured to set a duration for at least one solenoid coil to inductively heat the cookware object on the top surface of the top plate.

According to another aspect of the present disclosure, an inductive cooktop system includes a top plate that has a top surface for supporting a cookware object. A display is disposed vertically below the top plate. Induction coils are arranged in a matrix and disposed vertically below the display. The induction coils are each operable to generate a magnetic field partially extending above the top surface of the top plate. Also, a control system receives, at data processing hardware, an initial input selecting a cooking interface of several cooking interfaces. The control system generates, by the data processing hardware, a graphic corresponding to the selected cooking interface and illuminating the display with the graphic, where the graphic has at least one cooking area. Further, the control system activate at least one of the induction coils below the at least one cooking area on the graphic to inductively heat the cookware object on the top surface of the top plate over the at least one cooking area.

In some implementations, the control system is further configured to generate a selectable menu graphic alongside the cookware object. In some examples, the control system receives, at the data processing hardware, a selection input for a menu item graphic displayed in the selectable menu graphic. In response to the selection input, the data processing hardware adjusts the display and/or the induction coils to correspond with the selection input. Also, in some examples, the control system is further configured to adjust power supplied to the activated coil or coils of the plurality of induction coils to correspond with the selection input. For example, the selectable menu graphic may include a temperature dial corresponding to a temperature generated by at least one of the plurality of induction coils inductively heating the cookware object on the top surface of the top plate. In some examples, the selectable menu graphic includes a digital cooking timer that is configured to set a duration for at least one of the plurality of induction coils to inductively heat the cookware object on the top surface of the top plate.

In further implementations, the selected cooking interface may include a first mode or a second mode. The first mode may be configured to display the cooking area at a location determined by a sensed position of the cookware object on the top plate. In contrast, the second mode may be configured to display the cooking area at a fixed and discrete location on the top plate. For examples, the second mode may display a graphic over the display that resembles a gas range with at least two discrete burners.

### BRIEF DESCRIPTION OF DRAWINGS

FIG. 1A is a perspective view of an example countertop with an inductive cooktop.

FIG. 1B is a perspective view of an example disc-shaped induction coil disposed below a pan resting on an inductive cooktop.

FIG. 1C is a schematic view of an example magnetic field generated by the induction coil shown in FIG. 1B.

FIG. 1D is a schematic view of an example magnetic field generated by a C-shaped induction coil.

FIG. 1E is a schematic view of an example of a stack of layers corresponding to the inductive cooktop of FIG. 1A.

FIG. 2A is a top view of the inductive cooktop of FIG. 1A.

FIG. 2B is a top view of an example graphic interface for the inductive cooktop of FIG. 2A.

FIG. 2C is a perspective top view of an example graphic interface for the inductive cooktop of FIG. 2A.

FIGS. 2D-2H are top views of example graphic interfaces for the inductive cooktop of FIG. 2A.

FIG. 3A is a perspective view of a rotatable knob.

FIGS. 3B and 3C are perspective views an example insulator for a cookware object for the inductive cooktop of FIG. 1A.

FIG. 4A is a top plan view of an example arrangement of induction coils for the inductive cooktop of FIG. 1A.

FIG. 4B is an enlarged view plan view of the induction coils at section A/B shown in FIG. 4A schematically showing magnetic fields generated by the induction coils.

FIG. 4C is an enlarged view plan view of the induction coils at section A/B shown in FIG. 4A schematically showing the magnetic fields aligned with the data lines of the display panel.

FIG. 4D is a perspective view of the induction coils taken at section A/B shown in FIG. 4A and the corresponding magnetic fields.

FIG. 5 is a schematic view of an example computing device that may be used to implement the systems and methods described herein.

Like reference symbols in the various drawings indicate like elements.

### DETAILED DESCRIPTION

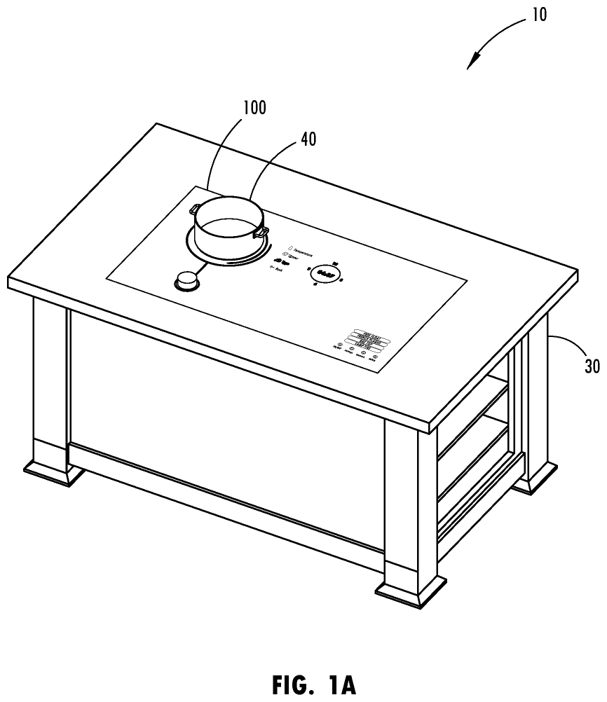

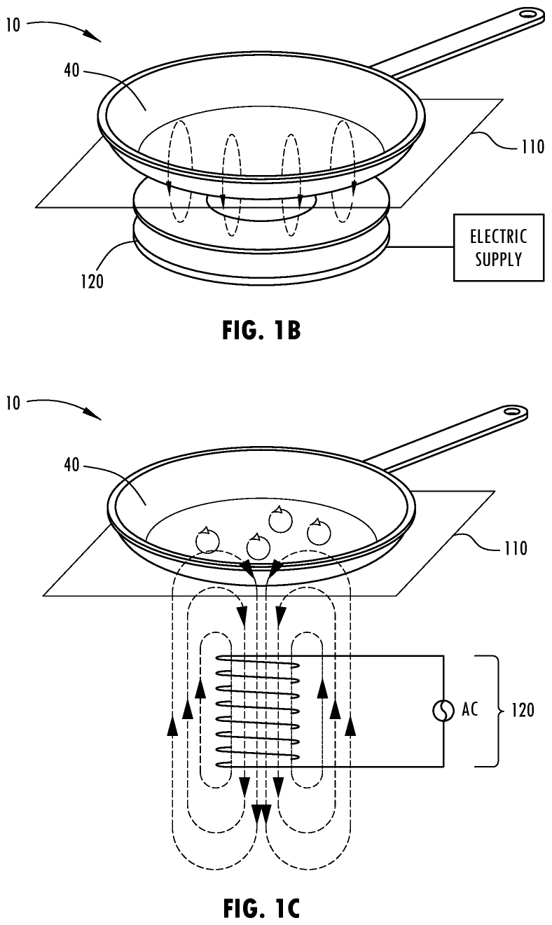

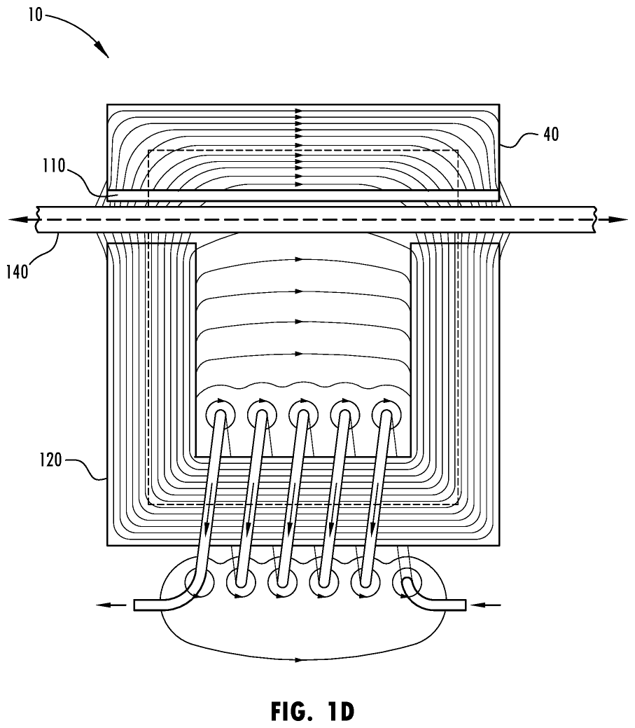

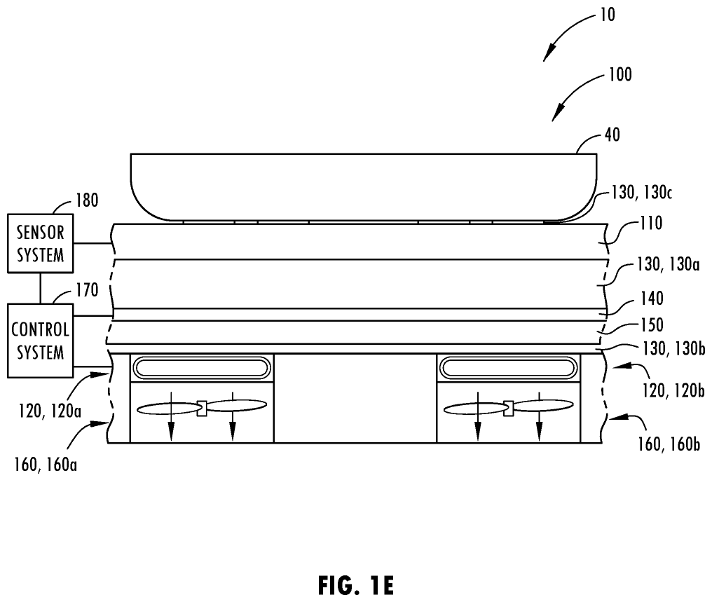

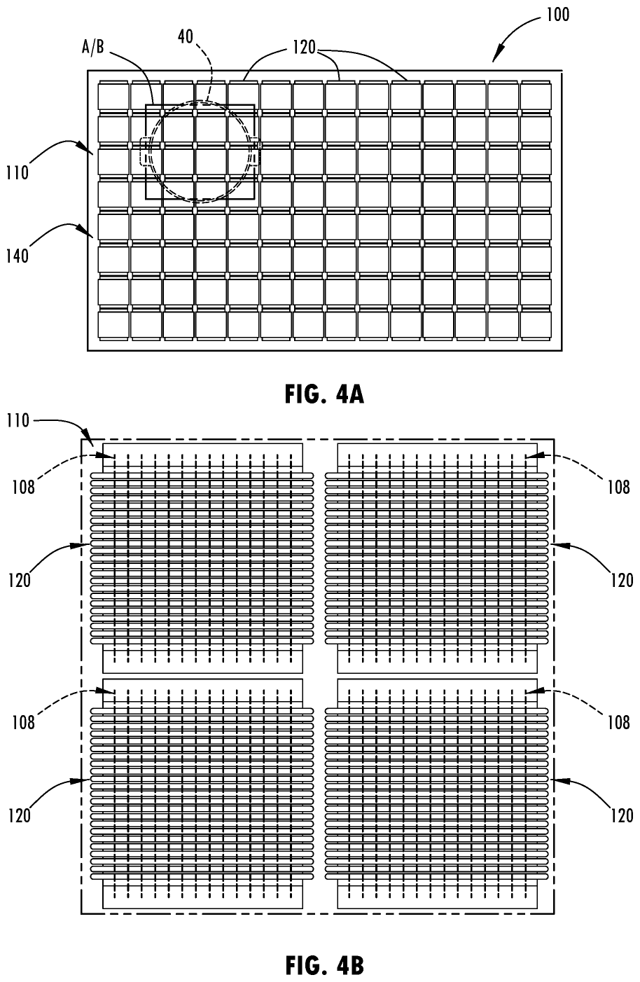

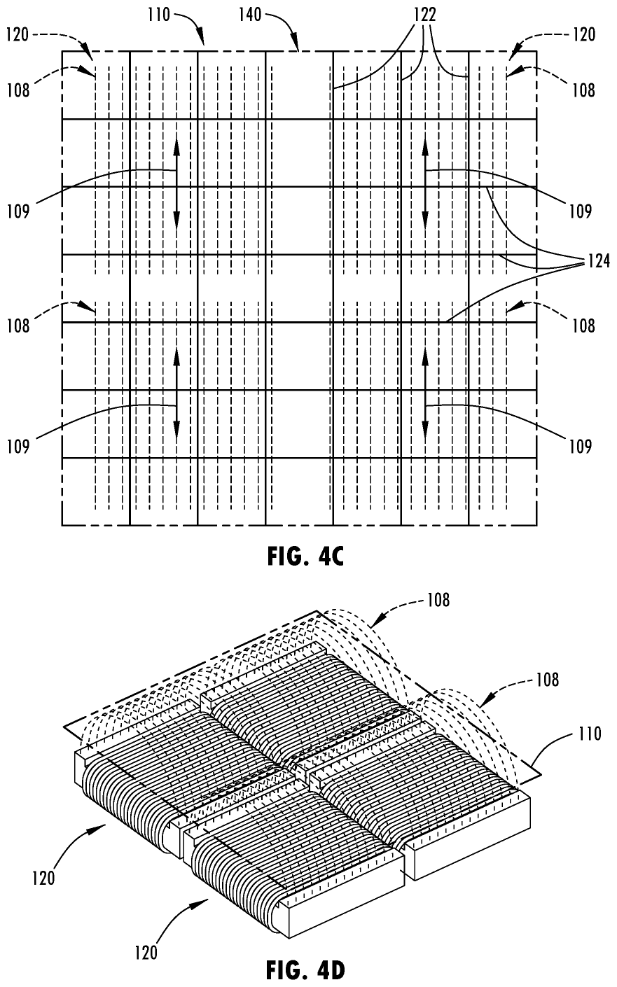

Referring to FIG. 1A, in some implementations, an inductive cooktop system 100 is provided in a kitchen environment 10 or other area used to prepare and cook food. For example, FIG. 1A illustrates the inductive cooktop system 100 installed in a countertop 20 of a cabinet 30 within the kitchen environment (e.g., a kitchen island). As shown in FIGS. 1B and 1C, the inductive cooktop system 100 includes a top plate 110 (e.g., a transparent glass and/or ceramic panel) and an induction coil 120 (e.g., a solenoid coil) that is disposed below the top plate 110. Here, the induction coil 120 may refer to a solenoid coil of various shapes or configurations ranging from a C-shaped coil where each end of the “C” is adjacent to the top plate 110 (e.g., shown in FIG. 1D and 4) to a more traditional pancake coil. The induction coil 120 may refer to a single coil or a plurality of coils (e.g., shown as an array of coils in FIG. 4A) below the top plate 110.

A power supply may supply alternating current, such as high-frequency or medium-frequency current, to the induction coil 120 to create an electromagnetic field that can inductively couple with and heat a cookware object 40 (e.g., a pan) supported on an upper surface of the top plate 110. The electromagnetic field may permeate through the upper surface of the top plate 110 in the area immediately above the induction coil 120, such as shown in FIGS. 1B, 1C, and 1D. The electromagnetic field oscillates to create eddy currents in or near the bottom portion of the cookware object 40 that is supported on the top plate 110, such that the resistance of the cookware object 40 to the eddy currents causes resistive heating of the cookware object 40. Thus, the inductively heated cookware object 40 may heat and cook the contents within the cookware object 40. To adjust cooking settings, such as temperature, the power (e.g., via the current) supplied to the induction coil 120 may be adjusted.

The cookware object 40 may include a ferrous metal, such as at least at a base of the cookware, to be capable of inductively coupling with the induction coil 120 and conductively spreading the heat to the cooking surface within the object 40. Also, the cookware object 40 may include various types of cooking vessels, such as a pot, a pan, an induction plate, a wok, and the like. It is also contemplated that the cookware object 40 may be product packaging, such as a metal food packaging that is configured to be used without an underlying piece of cookware. Further, it is contemplated that the object 40 may be an electrical device that is configured to inductively couple with the induction coil 120 to transfer data or power via the inductive coupling. Such an electrical device may include a small kitchen appliance, such as a toaster or blender, a receptacle unit for plugging in other devices powered via electrical wires, or other personal electronic devices, such as cell phones.

In some configurations, such as when the system 100 includes a display element (e.g., shown as display panel 140), the configuration and/or construction of the coils 120 may aid in mitigating coupling effects of the alternating magnetic field generated by the coil 120. In some examples, such as FIG. 1D, the coil 120 is constructed as a c-core solenoid coil magnet to align the magnetic field line or flux in a given direction. Also, the induction coils in FIGS. 4A-4D include an arrangement of c-core induction coils 406 that are each positioned to align the magnet fields in a common direction. By properly orientating the c-core solenoid coil magnet with a display element (e.g., a display panel 140), metal or conductive lines in the display (e.g., the backplane of the display), which may be most vulnerable to electrical interference, are aligned parallel or generally parallel to the magnetic filed lines. Additionally or alternatively, metal or conductive lines in the display (e.g., the backplane of the display) that are identified as less vulnerable or least vulnerable to electrical interference may be aligned orthogonal to the magnetic field lines.

Referring to FIG. 1E, in some examples, the inductive cooktop system 100 includes one or more dissipation layers 130 and a display panel 140 between the cooktop surface 110 and the induction coil 120 (also referred to as a coil layer 120). Here, a dissipation layer 130 may act as a thermal insulator such that heat generated by the coil layer 120, the display panel 140, and/or the cooktop surface 110 (e.g., via the cookware object 40) may be dissipated during operation of the cooktop system 100. This dissipation may help prevent malfunction and/or failure of different layers of the system 100, such as the display panel layer 140. A dissipation layer 130 may be a thermal insulating material or an air gap that allows air to flow between the layers. Here, in FIG. 1E, the system 100 includes a first dissipation layer 130a between the cooktop surface 110 and the display panel 140, a second dissipation layer 130b between the display panel 140 and the coil layer 120, and a third dissipation layer 130c between the cookware object 40 and the cooktop surface 110. Although the system 100 illustrates three dissipation layers 130, 130a —c, the system 100 may include any number of dissipation layers 130. In some examples, in order to maintain the position of each layer, one or more layers of the system 100 may have structural standoffs. Additionally or alternatively, the system 100 or portions thereof may be fixed in position by a frame structure corresponding to the system 100.

Beneath the display panel 140, a support layer 150 (e.g., a glass support layer) provides a non-conducting support for the display panel 140. Below the support layer 150, a second dissipation layer 130b is shown separating the display panel 140 from the coil layer 120 (e.g., shown as two coils, 120, 120a-b). Beneath the coil layer 120, the system 100 may additionally include a cooling layer 160. For instance, each coil 120a-b includes a downdraft fan 160, 160a-b that functions to draw heat downward and away from the layers above the coil layer 120 (e.g., the display 140 or the cooktop surface 110). Additional or alternative cooling systems, such as heat sinks or liquid cooling, may be employed in additional examples to draw heat away from the coils.

The display panel 140 generally operates by coordinating the emission of light to generate graphics or other content information. For instance, based on this operation, a user perceives the emission of light as a display projected on the cooktop surface 110. Here, the display panel 140 is an organic light emitting diode (OLED) display panel that emits light using one or more OLEDs. In additional examples, the display panel may be a thin-film-transistor liquid-crystal display (TFT LCD) panel, a light-emitting diode display (LED) panel, a plasma display panel (PDP), a liquid-crystal display (LCD) display panel, a quantum dot display (QLED) panel, or an electroluminescent display (ELD) panel. However, to use an OLED display panel 140 in conjunction with an induction coil layer 120, the system 100 needs to ensure that the OLED display panel 140 functions in particular operating conditions. For instance, the operation of the OLED display panel 140 may be diminished or compromised if the OLED display panel 140 is subjected to too much heat or too much electrical interference from a magnetic field associated with the coil layer 120.

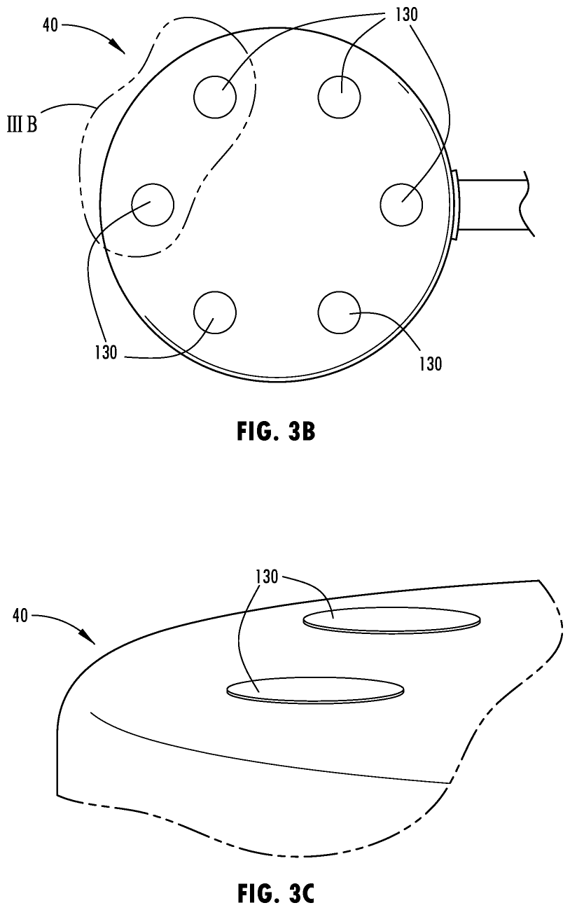

Referring to FIG. 1E, one or more dissipation layers 130 may function to dissipate heat from a hot object resting on the cooktop surface 110. In some examples, in order to properly dissipate heat, the OLED display panel 140 may be offset from the cooktop surface 110 or the heat source itself (e.g., the cookware object 40) by a threshold distance. For instance, the first dissipation layer 130a has a thickness that is greater than or equal to the threshold distance to provide a space for sufficient insulation to prevent a hot object (e.g., the cookware object 40) resting on the cooktop surface 110 from damaging the display 140. In some examples, in addition or alternative to the dissipation layer 130 between the display 140 and the cooktop surface 110, the display 140 is offset from the cookware object 40 (i.e., the heat source on the cooktop surface 110) by a dissipation layer 130 between the cooktop surface 110 and the cookware object 40 (e.g., the third dissipation layer 130c). For instance, the third dissipation layer 130 corresponds to one or more silicon pads (e.g., as shown in FIGS. 3A and 3B) or some other type of heat resilient insulator. Here, the third dissipation layer 130 between the cooktop surface 110 and the cookware object 40 may be constructed of a material that does not damage the cooktop surface 110 by scratching or low impact contact forces. By having a dissipation layer 130 between the cookware object 40 and the cooktop surface 110, the dissipation layer 130 may prevent or reduce conductive heating of the cooktop surface 110.

In some implementations, the threshold distance may depend upon the type(s) and/or density of insulation used in the space. Additionally, the dissipation layer 130 may have transparent properties (e.g., optical clarity) to prevent blurring or otherwise distorting the image quality of the display 140 when the dissipation layer 130 is beneath the cooktop surface 110. Here, this type of dissipation layer 130 may be referred to as a transparent thermal insulator. The transparent thermal insulator may be a gas, liquid, or solid state insulation. In the case of gas or liquid, the insulating material may also flow through the space being heated to remove heat being transferred to the corresponding insulating material. The transparent thermal insulator may also include a silica aerogel material that is disposed at one or more locations between an upper display surface of the display 140 and the upper surface of the top plate 110. The transparent thermal insulator may be integrated with the top plate 110 or may be disposed between the top plate 110 and display 140, such that the top plate 110 may be a homogenous panel (e.g., a glass panel).

In some examples, the inductive cooktop 100 includes a control system 170, such as control system circuitry, that is configured to detect or to receive inputs from a sensor system 180 and to perform processing tasks related to those inputs. In some configurations, the control system 170 is coupled to or in communication with the coil layer 120, the display 140, and/or the sensor system 180. For instance, the control system 170 may be physically wired to interfaces of these elements or communicate wirelessly with these elements. With respect to the display panel 140, the control system 170 is configured to control the display panel 140, such as to display information at the cooktop surface 110, including at an area or areas of the upper surface that interfaces with a cookware object 40 that is inductively coupled with an induction coil 120. The control system 170 may control information displayed by the display panel 140 before, during, or after operation of the induction coil 120 inductively coupling with a cookware object 40. Some examples of information displayed by the display panel 140 include operational information of the cooktop, outlines of cooking zones or control interfaces, control interface images, media widows or information, or branding or advertising windows or information and other conceivable images and graphics. In some implementations, to control the display 140, the control system 170 is configured to control individual pixels of the display 140 by interfacing with and controlling voltage, current, and/or other signals to a pixel circuit.

In addition to controlling the display 140, the control system 170 is configured to control the coil layer 120. Here, the control system 170 may supply power (e.g., in the form of voltage or current) to one or more coils 120 of the coil layer 120 to activate, deactivate, or adjust the characteristics of the coil 120 (e.g., adjust the heating power of one or more coils 120).

In some configurations, the control system 170 includes more than one controller. Here, each controller may operate individually or communicate with each other to control some portion of the system 100. For instance, each of the display 140, the coil layer 120, and/or the sensor system 180 may include its own controller(s) that collectively form the control system 170. For example, different types of controllers may be used throughout the system 100 depending on the communication protocols required or the type of information/data that is being communicated.

In some examples, the display 140 (e.g., via the control system 170) is configured to receive inputs from interaction with the system 100. For instance, the display 140 receives inputs corresponding to interaction at a top surface of the cooktop layer 110 by a user of the system or an object associated with the user. Based on these inputs, the display 140 (e.g., via the control system 170) is configured to generate content or content information and to display the generated content on the display 140 for the user to perceive at the cooktop surface 110. In other words, the display 140 may function as a user interface 200 that generates content, modifies content, or removes content in the form of images, multimedia, indicators, etc.

Generally speaking, a sensor system 180 may be configured to receive or to detect a variety inputs associated with the system 100 (e.g., associated with the cooktop surface 110 or the spatial area about the cooktop surface 110) and to communicate these inputs to the control system 170 in order to control elements, such as the display 140 and/or the coil layer 120. Although the inputs are described herein as detected by the sensor system 180, the control system 170, the display 140, and/or the coil layer 120 may be configured to receive/detect these inputs directly or independently of a sensor system 180. Some of these inputs include direct inputs from the user, such as touch inputs or other contact based inputs, or indirect inputs from the user, such as inputs channeled and/or communicated by an object associated with the user. For instance, the sensor system 180 is configured to receive inputs from peripherals associated with the display 140 and/or system 100, such as a keyboard, a mouse, a stylus, a remote control (e.g., the knob of FIG. 3A), microphone, camera, image scanner, etc. These peripherals may use wired or wireless protocols (e.g., Bluetooth, near-field communication, radio frequencies (RF) such as RFID, etc.). In some examples, the sensor system 180 receives indirect inputs from sensors that identify a presence of an object (e.g., a cookware object 40) on the cooktop surface 110 or adjacent to the cooktop surface 110 (e.g., in a range of the sensor system 180 within a spatial area about the cooktop surface 110) or characteristics associated with such an object (e.g., temperature, position, orientation, etc).

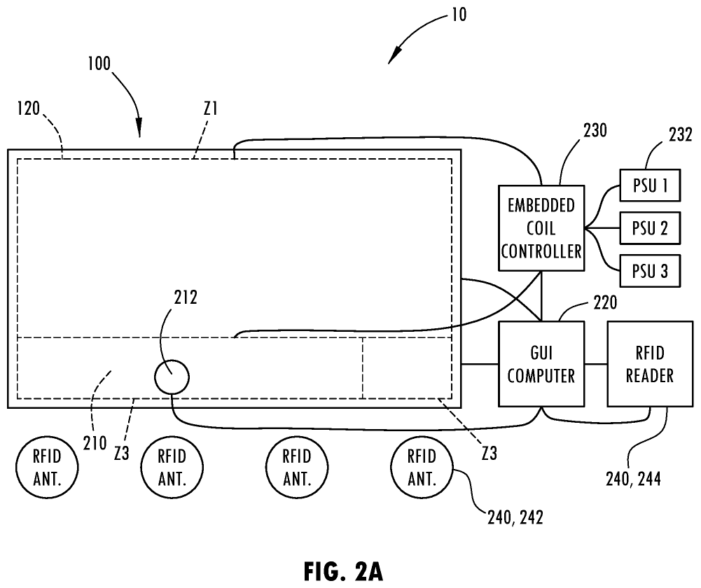

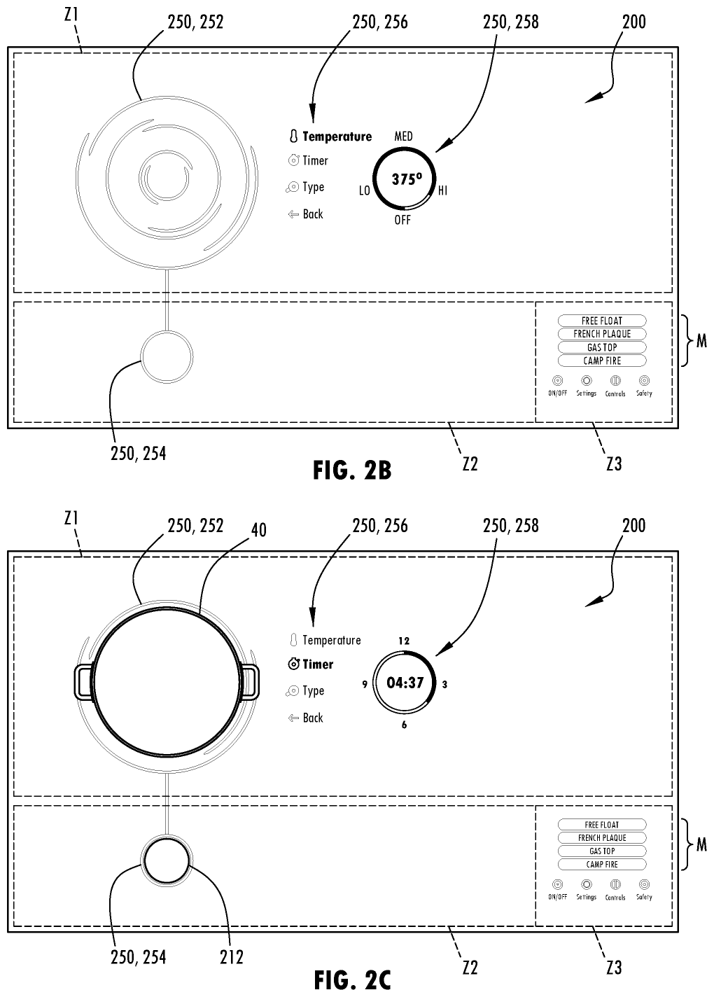

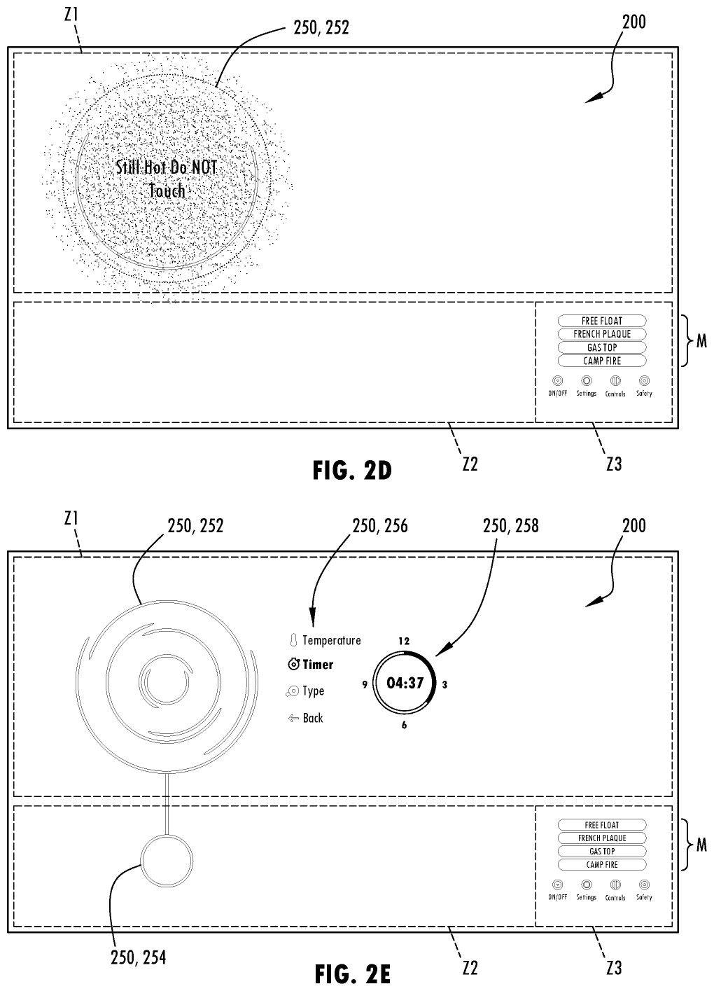

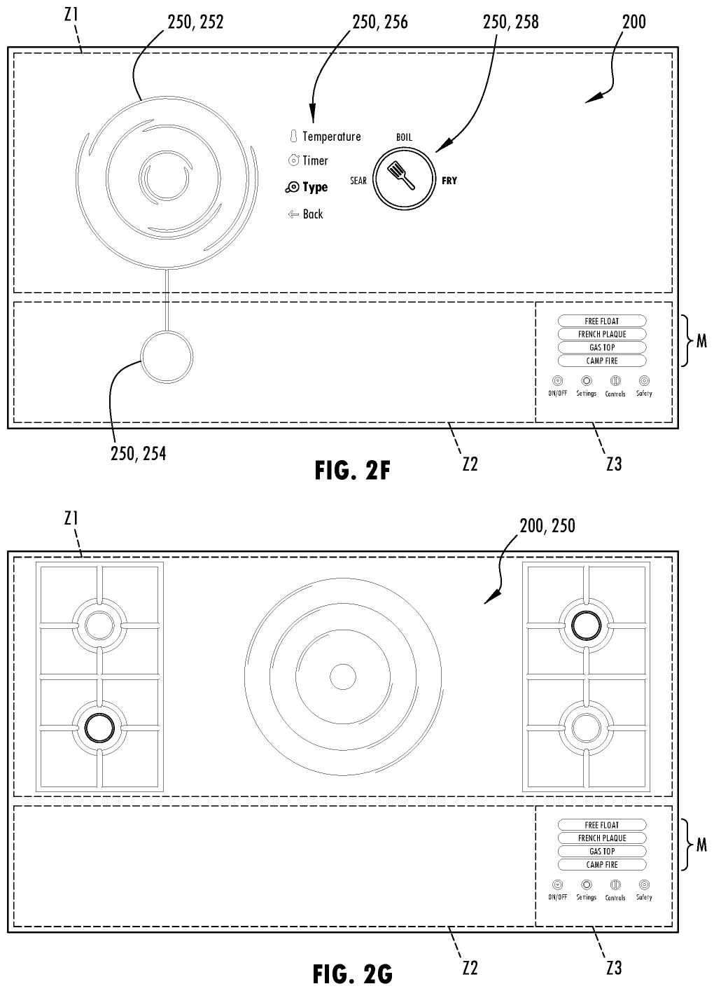

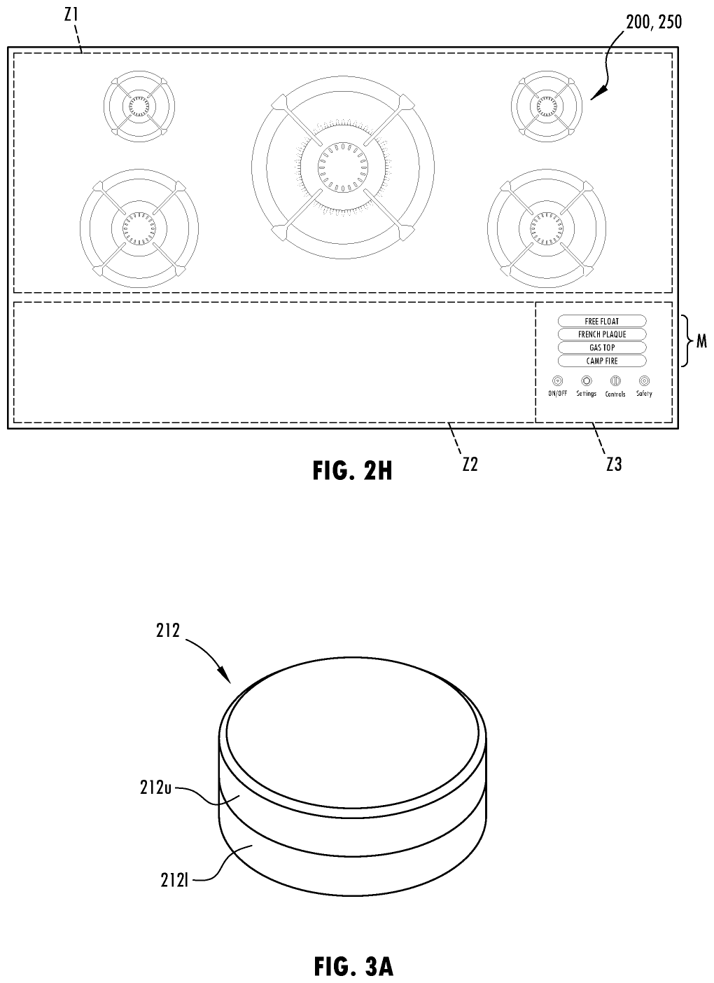

Referring to FIG. 2A, the cooktop system 100 may be configured in zones Z that permit different types of functionality. In other words, the circuitry in a zone Z directly above the coil layer 120 (e.g., a first zone Z1 shown as the multi-coil heating zone) is setup differently from circuitry in a zone Z not directly above the coil layer 120 (e.g. a third zone Z3 shown as touch corner zone). For example, some types of displays or sensors may have a particular type of circuitry configuration that is necessary to provide its functionality. With the use of an inductive cooktop operating based on one or more coils 120 (e.g., the matrix coil array shown in the first zone Z1), the circuitry of other components (e.g., sensors or displays) may need to be altered or positioned differently to accommodate for the magnetic field and induced voltage generated by the coil layer 120. In some configurations, each zone Z has one or more types of user functionality for the user interface 200.

In some implementations, such as FIG. 2A, a plurality of coils 120 form an array of coils (e.g., an array of columns and rows as shown in FIG. 4A) that provide a large surface for heating multiple pieces of cookware simultaneously (e.g., shown as the first zone Z1). The coils 120 (e.g., C-core coils) generate magnetic fields with a direction parallel to OLED display data lines. One or more other coils 210 may form a second zone Z2 referred to as a controller location area that senses the presence of a controller (i.e., a knob 212 as shown in FIG. 3A). Here, the coils 210 in the second zone Z2 may be the same coils as those that form the multi-core heating area of the first zone Z1, or alternatively may be different coils (e.g., spiral or pancake coils). The user interface 200 may also include a third zone Z3 that corresponds to touch corner configured to receive touch inputs from a user of the inductive cooktop (e.g., to control the display 140 with the control system 170). It is also contemplated that the touch corner may extend over more of or the entire display area in additional examples. In these examples, the display 140 and/or control system 170 includes a graphical user interface (GUI) computer 220 that is capable of receiving inputs from the user that occur in the touch corner Z3 and process the inputs to control the display 140 and/or coil layer 120. Additionally, an embedded coil controller 220 may receive inputs from the touch corner Z3 (via the GUI computer 220) and/or the controller location area Z2 when a knob 212 is present to control the power provided to the coils 120, 210. One or more power supply units (PSU) 232 provide the power to the embedded coil controller 230, which in turn distributes the power to the coils 120, 210. In some examples, each coil 120, 212 has its own driver that the controller 230 provides power to when enabling the coil 120, 210. In other examples, multiple coils 120, 210 share the same driver (e.g., via a solid-state switch) and the controller 230 controls multiple coils 120, 212 simultaneously via the shared driver. Portions of the cooktop 100 (e.g., the controller location area Z2) may provide wireless power to compatible devices placed atop the cooktop. To illustrate, the controller or knob 212 may charge or power itself when it is located in the controller location area Z2.

In some examples, the inductive cooktop 100 includes a radio frequency identification (RFID) system 240. The RFID system 240 may include one or more radio-frequency identification (RFID) antennas 242 and an RFID reader 244 to detect RFID tags placed on, or within range of, the RFID antennas 242. For example, the RFID system 240 identifies an RFID tag disposed on an object placed on the cooktop 100 to identify characteristics of the object and associated data. For example, the object may include product packaging with an embedded RFID tag, such as a metal food packaging that is configured to be used without an underlying piece of cookware. In some examples, the RFID system 240 is used as part of a product ordering process where the RFID system 240 communicates characteristics of the object that includes an RFID tag to an ordering system or an inventory system. Additionally or alternatively, the RFID system 240 may be used to generate notifications for the user. For instance, when the RFID system 240 identifies an RFID tag, the system 240 may relay this information to a user to generate a progress notification for a recipe or other cooking related task. In other words, the RFID system 240 recognizes an ingredient by an RFID tag and is configured to communicate this recognition (e.g., to communicate the completion of a recipe step or that more inventory is needed for the given object).

In some examples, the embedded coil controller 230 provides power to a particular coil 120 when the controller 230 determines that a cookware object 40 (i.e., a large piece of suitable metal) is present above the particular coil 120. This may increase the safety of the cooktop 100 by ensuring that the cooktop 100 does not attempt to heat non-cookware objects. In some implementations, the controller 230 may transmit a probe signal to each coil 120 to determine if an object is above the coil 120 (i.e., immediately above the cooktop surface above the coil). The probe signal, in some examples, includes providing a small amount of power (relative to the amount of power required to heat a cookware object) to the coil 120. That is, the probe signal may include an alternating current flowing through the coil 120. The controller 230 may measure a result from the probe signal to determine if a cookware object 40 is above the coil 120. For example, the controller 230 may determine the amount of power the coil 120 draws from a power rail when receiving the probe signal. When the power drawn or consumed satisfies a threshold amount, the controller 230 may determine that a cookware object 40 is above one or more coils 120 and when the power drawn fails to satisfy a threshold amount, the controller 230 may determine that a cookware object 40 is not above the coil 120. In addition to determining that no object is present above the coil 120, the controller 230 may additionally determine that an object present above the coil 120 is not the proper material, that the object is not large enough, and/or that the object is only partially over the coil 120, etc. In some examples, this process is not only used in a heating zone such as the first zone Z1, but also in a controlling zone such as the second zone Z2 to identify the presence and/or location of a controller 212 such as the knob 212.

In some examples, the controller 230 sends the probe signal to one coil 120 in the coil layer 120 at a time, and sequentially checks each coil 120. The controller 230 may wait for all coils 120 to be evaluated before enabling any of the coils 120. After all coils 120 have been evaluated, the controller 230 may enable or activate each coil 120 that the controller determines has a cookware object 40 above it. The controller 230 may enable a number of coils for one or more objects. Multiple coils 120 may be enabled for a single cookware object 40, and multiple cookware objects 40 may be heated simultaneously.

Optionally, the controller 230 may send the probe signal to more than one coil 120 at a time. The controller 230 may send the probe signal at frequencies other than the resonant frequency of a probed coil 120 to reduce the amount of current that is induced in other coils 120 in close proximity to the probed coil 120. Because other coils 120 may have the same resonant frequency as the probed coil 120, a probe signal at the resonant frequency may induce current in other coils 120 in addition to the probed coil 120. Current induced in coils 120 other than the coil 120 being probed may lead to inaccurate results (e.g., an object above a nearby coil may be determined to be above the probed coil). When the probe signal is at a frequency that is not near the resonant frequency, due at least in part to a high Q factor of the coils 120, the current may not be coupled. The controller 230 may probe multiple coils 120 at different frequencies simultaneously. In other examples, the controller 230 may probe coils 120 simultaneously that are greater than a threshold distance apart in order to limit or eliminate the amount of current that is induced in other probed coils 120. That is, two coils 120 that are of a sufficient distance apart to not couple may be probed simultaneously. The controller 230 may short circuit coils to ground (e.g., via field-effect transistors (FET)) coils 120 that are not currently being probed.

Referring to FIGS. 2B-2H, the user interface 200 may be able to generate various cooking graphics at the display 140 in response to inputs received by the control system 170 and/or the sensor system 180. In some examples, the user interface 200 includes different modes M that generate a particular set of graphics for the user interface 200. For example, FIGS. 2B-2H depict a plurality of modes M that are selectable in the touch input zone Z3 of the user interface 200. In this example, the modes M include a free float mode, a french plaque mode, a gas top mode, and a camp fire mode. As another example a banquet mode (i.e., a buffet or multi-dish warming mode) may be provided that includes discrete locations on the cooktop for multiple dishes to be kept warm for serving and optionally display a label near each dish or location that identifies the dish being warmed. dish being warmed. When the user generates a touch input corresponding to a selection of a mode M, the sensor system 180 receives this input as a particular signal that indicates the selected mode and communicates this information to the control system 170. The control system 170 then coordinates with the display 140 to have the display 140 generate graphical content corresponding to the selected mode M. In some configurations, a particular mode M may be programmed as a default mode for the system 100 when the system 100 is turned on. In some configurations, the user interface 200 includes a mode that allows the user to design or customize modes such that the user may generate modes with custom graphics or content. For instance, the user wants a square or brand name graphic as a tracking graphic or the general background graphic to correspond to the countertop color or resemble the sky (e.g., rather than black as shown). Additionally or alternatively, the touch input zone Z3 may be configured with other potential user selections, such as an on/off button touch area, a settings button touch area, a safety button touch area, or other buttons relating to controls for a cooktop.

FIGS. 2B, 2C, 2E, and 2F illustrate the user interface 200 with graphical content that corresponds to a free float mode M. A free float mode refers to a mode where graphics depicted on the user interface 200 in the cooking region (e.g., the first zone Z1) track one or more cookware objects 40 (also referred to as a tracking mode). This mode therefore allows a user to customize cooking space that may accommodate for user cooking preferences, the amount of cookware objects 40 present in the cooking region Z1, or the type/size of objects 40 present in the cooking region Z 1. For instance, a user may place a cookware object 40 customizably over one or more coils 120 in a position that prevents a child from grabbing a cookware object 40 that becomes hot.

In the free float mode, the display 140 is configured to generate a graphic 252 that corresponds to the cookware object 40 in the cooking region Z1 and/or a graphic 254 that corresponds to the controller 212 (e.g., the knob 212 shown in FIG. 2C) in the control region Z2. For example, the figures depict the user interface 200 with a graphic that outlines the cookware object 40 and the controller 212. In some examples, the display 140 generates this tracking mode graphic 250 by utilizing information from the controller 230 corresponding to the probe signal to the coil layer 120. In other words, the probe signal identifies positional information about the cookware object 40 within the cooking region Z1 that may be relayed to the display 140 for the display 140 to generate a tracking graphic at the position where the probe signal identifies the cookware object 40. This same technique may be used to display the location of the controller 212 using probe signals for coils 210 within the control region Z2.

In some examples, the display 140 generates the tracking graphic 252, 254 using inputs from the sensor system 180 rather than, or in addition to, the probe signal(s) associated with the controller 230. In some implementations, the display 140 generates a object tracking color sequence that displays a color pattern on the display 140. Here, the controller 212 and/or the cookware object 40 includes one or more color sensors. These color sensors are configured to detect a color beneath the controller 212 and/or cookware object 40 (collectively referred to as an object). In some examples, the color sensors detect the color beneath the object and the sensor system 180 and/or control system 170 refreshes the color pattern in the particular quadrant of the previously detected color. Here, this process may be repeated to achieve a particular positional accuracy for the position of the object over the display 140 such that in each iteration the color pattern is generated in the identified quadrant from the previous iteration. In other words, the system 100 uses an iterative color sensing process to identify the position of the object on the top plate 110 (e.g., the cookware object 40 or the controller 212). For instance, when the color sensor detects four blues in a row from four iterations of the sequence, the sensor system 180 and/or the control system 170 determines that the object is in the fourth blue quadrant of the fourth iteration. In some configurations, the display 140 is configured to generate this object tracking color sequence using a small number of frames each second (e.g., 2-4 frames per second (fps) out of 30 to 60 fps). By using only a small number of frames, the user may be unable to visually distinguish this tracking process.

The sensor system 180 may use a variety of sensors to detect or aid in the detection of the location of an object on or near the cooktop surface 110. In some examples, the sensor system 180 uses inputs detected from a microcontroller (MCU) (e.g., a 6-axis MCU) mounted on the object to provide positional/orientation information regarding the object. Here, the MCU may include an accelerometer that detects when an object is picked up, set down, or moved. In some configurations, an optical sensor is mounted on the object to determine positional/orientation information regarding the object. The sensor system 180 may additionally or alternatively be configured to coordinate with the RFID system 240 such that the object includes a component, such as an RFID tag, that is recognizable by the RFID system 240 to determine positional/orientation information of the object. In some examples, the sensor system 180 includes vision sensors to detect the position of the object. Here, the vision sensor(s) may be mounted on the edges of the cooktop system 100 (e.g., infrared sensors), overhead of the cooktop system 100 (e.g., on a hood or vent), or beneath the cooktop surface 110 (e.g., an holographic optical element coupled to a vision sensor that is embedded in one or more layers of the system 100). In some implementations, the sensor system 180 includes touch sensors within the user interface 200 to aid in the detection of the position of the object. These touch sensors may be non-capacitive touch technology. For instance, the touch sensors are surface acoustic wave (SAW) touch sensors that monitor a sound frequency on the cooktop surface 110. Here, these SAW touch sensors may include a transmitter (e.g., mounted to an edge of the cooktop surface 110) that emits sound waves that propagate through the cooktop surface 110 to be received by ultrasound receivers. Here, the system 100 may be configured to use any combination of sensors or sensing sequences to define the position of the object above the display 140.

In some examples, the sensor system 180 may also use these sensors to detect or aid in the detection of foreign objects (i.e., non-cookware objects, such as electronic devices, cooking ingredients, utensils and the like) placed on the cooktop surface. Also, or in the alternative, the induction coils may be used to sense foreign objects that do not have an inductive resistance within a tolerance range for compatible cookware. The detection of such a foreign object may be communicated to the user, such as via a displayed notification or graphic or audible sound to alert the user of the presence of the foreign object. For instance, if the foreign object is near a heated cookware object, the notification may recommend that the user move the foreign object to avoid interference with heating or undesirable heating of the foreign object.

The display 140 may additionally be configured to generate graphical content 250, 256, 258 that conveys cooking information. For example, the display 140 generates a graphic 250 that corresponds to a selectable menu 256. Here, the controller 212 or other control means (e.g., a peripheral or the touch area) may be used by the user to select cooking information items from the menu 256. For instance, FIGS. 2B, 2C, 2E, and 2F illustrate a menu 256 that includes selectable display options such as temperature, timer, and type. FIG. 2B illustrates that the user has selected, as a user input, the menu option of temperature. Based on this user selection (e.g., using the controller 212), the display 140 generates a graphic 250, 258 that identifies the current cooking temperature. In some examples, the temperature or a power representation corresponding to the one or more active coils 120 may be displayed at the cookware object 40 (e.g., shown as a graphical halo around the displayed temperature or cookware object). While a menu item is selected, the user (e.g., using the controller 212) may be able to adjust settings or configurations corresponding to that selection. In other words, when the temperature is selected, the user may change the temperature setting from HI to MED As another example, when the user selects the timer menu, as shown by FIGS. 2C and 2E, the user may use the user interface 200 to configure a cooking time. For instance, FIGS. 2C and 2E illustrate the display 140 generating a cooking timer graphic 258 based on the user input. When the user selects the menu option of type (e.g., as shown in FIG. 2F), the display 140 is configured to generate a graphic 258 that illustrates the different types of cooking settings that are selectable to the user. As shown by these figures, the system 100 is customizable for various cooking settings and to convey different types of cooking information. Additionally, this system 100 enables the display 140 to generate graphical content in or near the cooking area Z1.

Referring to FIG. 2D, the user interface 200 may be configured to generate safety notifications based on a state of the system 100. For instance, FIG. 2D depicts that the display 140 generates a graphic 250 that conveys that an area where a cookware object 40 was previously heated is still hot. This notification graphic is helpful for inductive cooking because without such a graphic, a user may not be able to tell that the area is still hot (i.e., dangerous). In some examples, the display 140 is configured to generate this notification graphic for a particular duration after the cookware object 40 is removed. For instance, the display 140 generates the notification graphic based on an algorithm that accounts for cooking duration (i.e., the length of time the area was heated) and/or the temperature of the cooking in the area. Additionally or alternatively, the algorithm accounts for infrared temperature information from an IR temperature sending unit. In other words, in some examples, an IR sensor of the sensor system 180 monitors the temperature of the cookware object 40 during heating and this temperature information may be incorporated into the algorithm that determines a length to display the notification graphic 252. In these examples, the IR sensor may be mounted adjacent to or embedded with one or more layers of the system 100. For example, the IR sensor senses temperature of the cookware object 40 through the transparent display 140.

FIGS. 2G and 2H illustrate other example modes M that are selectable by the user of the user interface 200. Here, unlike the free floating mode, these modes may fix the coils 120 to be used during cooking. In other words, as shown in FIGS. 2G and 2H, when the user selects either the French plaque mode or the gas top mode, the display 140 generates graphics 250 that depict set positions or discrete cooking areas (e.g., resembling traditional burners) to heat a cookware object 40. In other words, these modes provide fixed position cooking instead of the customizable tracking mode previously described. Here, the French plaque mode results in a graphic 250 with large burner image in the center of the cooking area Z1 and four burners on the corners of the large center burner characteristic of a French plaque range or simmer plate. The large burner of the French plaque has concentric rings that define different temperature zones of the burner, such as the central ring being the hottest or highest temperature capability and the rings radiating out from the center ring provide progressively decreasing temperatures. For example, the outward rings provide space to place pots that need a low boil and farther away from the center ring provides space for gently simmer dishes and finally, at the edge, space to gently warm things, such as melting butter or chocolate without burning them. In contrast, the gas top mode generates a graphic 250 that depicts gas-style burners. Here, in the gas top mode, the user interface 200 may include some form of tracking to, for example, determine the cooking area where the user is cooking with a cookware object 40 and to generate a graphic 250 corresponding to that cooking position. For example, in FIG. 2H, the display 140 generates a graphic 250 with a blue flame ring encircling a center of a burner that is nearest to the determined cooking area.

FIGS. 3A-3C illustrate accessories that may be used in conjunction with the user interface 200. FIG. 3A is an example of a controller 212 that may be used in the control region Z2 of the user interface 200. The controller 212 may have a lower portion 2121 that is configured to magnetically attach at the upper surface of the top plate 110 and an upper portion 212u that is configured to receive user inputs for controlling at least one of the induction coil 120 and/or the display 140. The upper portion 212u of the controller 212 may include a rotatable knob or dial that is rotatable to provide user inputs that correspond with a radial position of the rotatable knob, such as to adjust temperature or cooking time or the like. The upper portion 212u may provide haptic feedback to the user, such as in response to rotation of the knob to a different setting or selection. It is also contemplated that the upper portion 212u may be configured with additional or alternative input devices, such as button, capacity touch sensor, slider, switch, or the like to provide user inputs to the control system 170 of the inductive cooktop 100. By selecting a link, such as via pressing down on the upper portion 212u of the rotatable controller 212 or dial to actuate a button, the controller 212 may actuate the selected link, disappear, reposition, or minimize or various other conceivable user interface functionality.

In some examples, the controller 212 includes one or more safety features for the cooktop 100. For instance, the cooktop 100 is configured such that if the controller 212 is removed (e.g., completely from the cooktop surface 110 or from the controller area Z2), the coil layer 120 entirely deactivates. In some examples, the user interface 200 includes a deactivation position where when the controller 212 is moved to the deactivation position, the control system 170 deactivates all coils 120. In some implementations, the controller 212 has a feature that when the controller 212 is held down for a set duration of time, the control system 170 deactivates all coils 120. For instance, when the user holds down a switch button on the controller 212 that activates when the user presses down on the upper portion 212u of the controller 212 relative to the lower portion 2121 for five seconds, the control system 170 deactivates all coils 120. In some configurations, controller 212 is configured such that when the user clicks the controller 212 a set number of times (e.g., three times), the control system 170 deactivates all coils 120. The controller 212 may include any number of these coil deactivation safety features.

Further, as previously mentioned, FIGS. 3B and 3C depict examples of a dissipation layer 130 (e.g., a silicon pad) that may be applied to the cookware object 40 to generate a dissipation layer 130 between the cooktop surface 110 and the cookware object 40. By having a dissipation layer 130 at this position, the dissipation layer 130 may reduce and/or limit the amount of conductive heat from the cookware object 40. Although not shown, the cookware object 40 may include its own temperature sensors as part of the sensor system 180. With the cookware object 40 having its own temperature sensors, the control system 170 may receive temperature feedback or input directly from the cookware object 40. This direct measurement may allow the control system 170 to finely tune and/or control temperatures set by the user at the user interface 200. It may also enable time-based cooking such that the control system 170 may activate and/or deactivate coils 120 to satisfy cooking conditions specified by a temperature and a duration (e.g., cook the chicken at 350 degrees for eight minutes).

Although not shown, the inductive cooktop 100 may include speakers as a peripheral accessory among the layers of the system 100. In some examples, the speakers are mounted directly below the cooktop surface 110. For instance, the speakers take advantage of an air gap between the cooktop surface 110 and the display 140 to create an acoustic space for the system 100. In some configurations, the control system 170 utilizes the speakers for noise canceling purposes. For instance, the induction cooking process may emit a high pitch frequency or other undesirable audible sound. Here, the control system 170 may generate destructive interference to cancel these unwanted frequencies. In some implementations, the speakers may be part of an audio system controller by the control system 170 where the audio system includes more than one acoustic component, such as speakers, one or more microphones, one or more digital signal processors, and/or audio surface exciter(s). An audio system with audio surface exciters may use a surface of the cooktop 100 as a speaker (e.g., the cooktop surface 110 is a glass surface that functions as the speaker).

FIG. 4A is an example of the inductive cooktop system 100 where the display panel 140 is transparent to illustrate the system 100. Here, a top surface of each coil 120 of the array of induction coils 120 is depicted generally within the same plane. Yet this does not have to be the case. For example, different coils 120 within the array may be at different distances from the cooktop surface 110 (e.g., a bottom surface of the cooktop surface 110). In other words, each coil 120 may be set at a particular distance to the cooktop surface 110 independent of other coils 120 within the array. In some implementations, the coils 120 are arranged in a pattern based on their distance from their top surface of the coil 120 facing the cooktop surface 100 to the cooktop surface itself In some configurations, the coils 120 within the array are configured such that each coil 120 has some degree of adjustability in the x, y, and/or z-direction. Here, the z-direction corresponds to moving upwards or downwards with respect to the cooktop surface 110 while the x-direction corresponds to moving left or right and the y-direction corresponds to moving towards the foreground or the background.

In some examples, the coils 120 are held in a coil holder (e.g., a frame or container that supports the coils 120) where the coil holder is adjustable with respect to the cooktop surface 110 (e.g., adjustable upwards towards the cooktop surface 110 or downwards away from the cooktop surface 110). Additionally or alternatively, the system 100 may be constructed such that the display 140 is adjustable with respect to the coil layer 120. For instance, the coil layer 120 is fixed while the display 140 moves upward or downward. In other examples, both the display 140 and the coil layer 120 have some degree of adjustability within the system 100.

FIGS. 4B-4D are an example of some of the induction coils 120 disposed below the cookware object 40 in FIG. 4A. As shown in FIG. 4C, the display panel 140 includes two sets of lines 122, 124 that are disposed orthogonal to each other to form a two-dimensional matrix that is configured to operate associated lighting elements with an addressing scheme. One set of lines are data lines 122 (i.e., high impedance lines) and the other set of lines are scan lines 124 (i.e., low impedance lines). The data lines 122 shown in FIG. 4C, when viewed in the Z-direction from above, are disposed vertically or longitudinally (i.e., in a column) on the display panel 140 and the scan lines 124 are disposed horizontally or laterally (i.e., in a row) on the display panel 140. The electrically actuated panel may be various types of illumination panels or other types of panels in other implementations of the inductive coils described herein. The induction coils 120 disposed below the display panel 140 are operable to generate an electromagnetic field 108 that inductively couples with the cookware object 40 supported at the transparent top plate. To avoid interference or damage to the data lines 122, induction coils 120 may emit a magnetic field 108 that is largely parallel to the data lines 122, and thus will minimize any induced voltage or current on the data lines 122. As shown in FIG. 4C, the induction coils 120 are operable to generate the electromagnetic fields 108 with a flux direction 109 in general parallel alignment with the data lines 122 to generally prevent the electromagnetic fields 108 from inducing a voltage on the data lines 122.

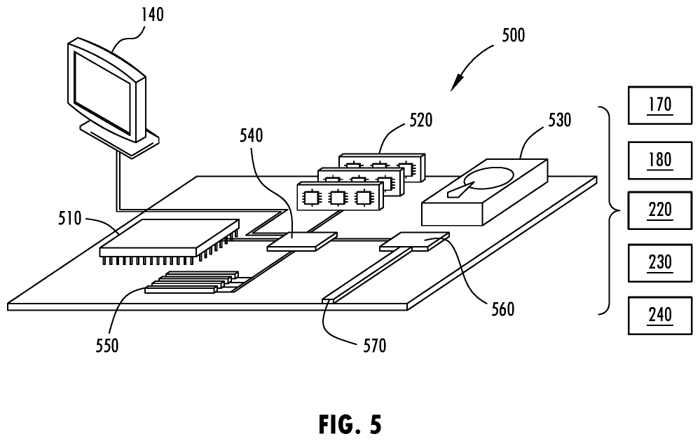

FIG. 5 is schematic view of an example computing device 500 that may be used to implement the systems (e.g., systems 100, 170, 180, 220, 230, 240) and methods described in this document. The computing device 500 is intended to represent various forms of digital computers/processors, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510 (e.g., data processing hardware), memory 520 (e.g., memory hardware), a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 140 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device (e.g., the display 140) or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

1. A method comprising:
receiving, at data processing hardware, an initial input indicating a position of a cookware object on a surface of an inductive cooktop;
determining, by the data processing hardware, a plurality of pixels of a display corresponding to the indicated position from the input, the display coupled with the inductive cooktop; and
generating, by the data processing hardware, a graphic representing at the indicated position for the cookware object by illuminating the plurality of pixels of the display.

2. The method of claim 1, further comprising:
receiving, at the data processing hardware, a second input indicating a change of position of the cookware object on the surface of the inductive cooktop;
determining, by the data processing hardware, a second plurality of pixels of the display corresponding to the indicated change of position from the second input;
generating, by the data processing hardware, a second graphic at a respective position corresponding to the indicated change of position for the cookware object by illuminating the second plurality of pixels of the display; and
extinguishing, by the data processing hardware, the plurality of pixels corresponding to the initial input.

3. The method of claim 1, wherein generating the graphic representation further comprises generating a selectable menu graphic alongside the graphic at the indicated position for the cookware object.

4. The method of claim 3, further comprising:
receiving, at the data processing hardware, a selection input for a menu item graphic displayed in the selectable menu from a peripheral device in contact with the inductive cooktop; and
determining, by the data processing hardware, a second plurality of pixels of the display corresponding to an area adjacent a position of the selectable menu; and
generating, by the data processing hardware, a third graphic representing cooktop information for the inductive cooktop by illuminating the second plurality of pixels of the display.

5. The method of claim 4, wherein the graphic representing cooktop information comprises a temperature dial corresponding to a temperature generated by at least one solenoid coil inductively heating the cookware object on the surface of the inductive cooktop.

6. The method of claim 4, wherein the graphic representing cooktop information comprises a digital cooking timer configured to set a duration for at least one solenoid coil to inductively heat the cookware object on the surface of the inductive cooktop.

7. An inductive cooktop system comprising:
a top plate comprising a top surface for supporting a cookware object;
a display disposed vertically below the top plate;
a plurality induction coils arranged in a matrix and disposed vertically below the display, wherein the plurality of induction coils are each operable to generate a magnetic field partially extending above the top surface of the top plate; and
a control system configured to:
receive, at data processing hardware, an initial input indicating a position of the cookware object on the top surface of the top plate;
determine, by the data processing hardware, a plurality of pixels of the display corresponding to the indicated position from the input; and
generate, by the data processing hardware, a graphic representing at the indicated position for the cookware object by illuminating the plurality of pixels of the display.

8. The inductive cooktop system of claim 7, wherein the control system is further configured to:
receive, at the data processing hardware, a second input indicating a change of position of the cookware object on the top surface of the top plate;
determine, by the data processing hardware, a second plurality of pixels of the display corresponding to the indicated change of position from the second input;
generate, by the data processing hardware, a second graphic at a respective position corresponding to the indicated change of position for the cookware object by illuminating the second plurality of pixels of the display; and
extinguish, by the data processing hardware, the plurality of pixels corresponding to the initial input.

9. The inductive cooktop system of claim 7, wherein generating the graphic representation further comprises generating a selectable menu graphic alongside the graphic at the indicated position for the cookware object.

10. The inductive cooktop system of claim 9, wherein the control system is further configured to:
receive, at the data processing hardware, a selection input for a menu item graphic displayed in the selectable menu from a peripheral device in contact with the top surface of the top plate; and
determine, by the data processing hardware, a second plurality of pixels of the display corresponding to an area adjacent a position of the selectable menu; and
generate, by the data processing hardware, a third graphic representing cooktop information by illuminating the second plurality of pixels of the display.

11. The inductive cooktop system of claim 10, wherein the graphic representing cooktop information comprises a temperature dial corresponding to a temperature generated by at least one solenoid coil inductively heating the cookware object on the top surface of the top plate.

12. The inductive cooktop system of claim 10, wherein the graphic representing cooktop information comprises a digital cooking timer configured to set a duration for at least one solenoid coil to inductively heat the cookware object on the top surface of the top plate.

13. An inductive cooktop system comprising:
a top plate comprising a top surface for supporting a cookware object;
a display disposed vertically below the top plate;
a plurality induction coils arranged in a matrix and disposed vertically below the display, wherein the plurality of induction coils are each operable to generate a magnetic field partially extending above the top surface of the top plate; and
a control system configured to:
receive, at data processing hardware, an initial input selecting a cooking interface of a plurality of cooking interfaces;
generate, by the data processing hardware, a graphic corresponding to the selected cooking interface and illuminating the display with the graphic, the graphic having at least one cooking area; and
activate at least one of the plurality of induction coils below the at least one cooking area on the graphic to inductively heat the cookware object on the top surface of the top plate over the at least one cooking area.

14. The inductive cooktop system of claim 13, wherein the control system is further configured to generate a selectable menu graphic alongside the cookware object.

15. The inductive cooktop system of claim 14, wherein the control system is further configured to:
receive, at the data processing hardware, a selection input for a menu item graphic displayed in the selectable menu graphic; and
adjust, by the data processing hardware, at least one of the display or the plurality of induction coils to correspond with the selection input.

16. The inductive cooktop system of claim 15, wherein the control system is further configured to adjust power supplied to the activated coil or coils of the plurality of induction coils to correspond with the selection input.

17. The inductive cooktop system of claim 15, wherein the selectable menu graphic comprises a temperature dial corresponding to a temperature generated by at least one of the plurality of induction coils inductively heating the cookware object on the top surface of the top plate.

18. The inductive cooktop system of claim 15, wherein the selectable menu graphic comprises a digital cooking timer configured to set a duration for at least one of the plurality of induction coils to inductively heat the cookware object on the top surface of the top plate.

19. The inductive cooktop system of claim 13, wherein the selected cooking interface comprises a first mode or a second mode, the first mode configured to display the cooking area at a location determined by a sensed position of the cookware object on the top plate, and a second mode configured to display the cooking area at a fixed and discrete location on the top plate.

20. The inductive cooktop system of claim 19, wherein the second mode displays a graphic over the display that resembles a gas range with at least two discrete burners.

21. (canceled)
